(19) United States
(12) Patent Application Publication
(10) Pub. No.: US 2007/0215294 A1
(43) Pub. Date: Sep. 20, 2007

(54) Barrier with dual post wind resistance system

(76) Inventor: Mark R. Barrow, Milton, FL (US)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 11/384,080

(22) Filed: Mar. 17, 2006

(51) Int. Cl. E05D 15/00

(52) U.S. Cl. 160/209

(57) ABSTRACT

A door system (10) for a door opening defined by a pair of vertically spaced jambs (12), a header (13) positioned near the vertical extremity of the jambs (12), and a floor (F). The door system includes a door (D), a plurality of track sections (17-19), the door (D) being movable on the track sections (17-19), an exterior post (31) positioned forward of the door (D) and an interior post (32) positioned rearward of the door (D). The exterior and interior posts (31, 32) are adapted to oppose deflection of the door (D) during high wind conditions.

### TECHNICAL FIELD

In general, the present invention relates to movable barriers, such as garage doors. More particularly, the present invention relates a wind resistance system for such movable barriers to prevent damage to the barrier resulting from high velocity wind pressures. More specifically the present invention relates to a wind resistance system for doors having an externally mounted post and an opposed internally mounted post, wherein the posts prevent inward or outward movement of the barrier.

### BACKGROUND OF THE INVENTION

Generally, door systems are constructed to withstand a wide range of weather conditions. Yet, it has been found that high wind conditions, particularly those generated during hurricane and tropical storms, can cause damage or failure of door systems. These failures, whether from door buckling or derailing, can cause considerable damage to property and represents a health risk to home occupants. Thus, reinforcement assemblies are needed for protection against high wind conditions. Prior door reinforcement systems are often times complicated and difficult to install. Such difficulties arise because such designs include complex mounting brackets and often require a reinforcement member to be coupled to the door at a plurality of locations. The many installation steps are time consuming and often times home and business owners have little time to prepare for the high wind condition.

One problem area of prior art door reinforcement systems stems from the physical mounting of the reinforcement mechanism to one side of the door. Normally attachment occurs on the inside and requires a means of attaching a vertical reinforcement post or member to the garage door. This allows the vertical reinforcement to be internal to the structure while still providing reinforcement under both positive and negative wind pressures. Some barriers, such as garage doors, include lighter strength surface materials such as thin metals and plastic polymers such that attachment of the vertical reinforcement post or member to these surface materials is problematic. Further, these types of attachments are normally confined to a small surface area such that the stresses on the attachment points are very high during high velocity wind pressure occurrences. Many times these attachment points will fail during the high wind occurrence, prior to destruction of the barrier. Thus, even though the high wind incident did not destroy the door, replacement is necessary due to the damage caused by the failure of the reinforcement apparatus.

In view of these problems it has become evident that a need exists for a wind resistance system which may be quickly and easily installed prior to a high wind condition.

### SUMMARY OF THE INVENTION

In light of the foregoing, it is a first aspect of the present invention to provide a barrier with a dual post wind resistance system.

It is another aspect of the present invention to provide a door system for a door opening defined by a pair of vertically spaced jambs, a header positioned near the vertical extremity of the jambs, and a floor supporting the jambs, the door system comprising, a door, a plurality of track sections, the door being movable on the track sections, an exterior post positioned forward of the door, an interior post positioned rearward of the door, wherein the exterior and the interior posts are adapted to oppose deflection of the door.

Yet another aspect of the present invention is a wind resistance system for a movable door having an interior surface and an exterior surface, the wind resistance system comprising an exterior post positioned forward of the door, an interior post positioned rearward of the door, a footer bracket positioned below the door and a header mounting assembly positioned above the door, the interior and the exterior posts being releasably coupled to the footer bracket, and the interior and the exterior post being releasably coupled to the header mounting assembly, wherein the posts prevent excessive door deflection.

Still another aspect of the present invention is a method of preventing wind damage, the method comprising, providing a door movable on a plurality of tracks, moving the door to a close generally vertical orientation, providing an exterior post positioned forward of the door, providing an interior post positioned rearward of the door, securing the exterior and the interior posts against movement.

### BRIEF DESCRIPTION OF THE DRAWINGS

FIG. 1 is a rear perspective view of a door system including guide tracks attached to a framework that defines a door opening and a wind resistance system according to the concepts of the present invention;

FIG. 2 is a side elevational view of the door system and wind resistance system shown in FIG. 1;

FIG. 3 is an enlarged upper rear perspective view of a header support, a header bracket, a top bracket and posts of the wind resistance system with a door of the door system removed for clarity;

FIG. 4 is an enlarged upper front perspective view of the header support, header bracket, top bracket and an exterior post of the wind resistance system with the door shown;

FIG. 5 is an enlarged isometric view of the header support according to the concepts of the present invention; and

FIG. 6 is an exploded view of the header support, header bracket, top bracket and the posts of the wind resistance system shown in FIG. 3;

FIG. 7 is an enlarged lower rear perspective view of a footer bracket and posts of the wind resistance system with the door removed for clarity;

FIG. 8 is an exploded view of the footer bracket and posts of the wind resistance system shown in FIG. 5; and

FIG. 9 is an assembled sectional view of a footer bracket, pin and bolt of the wind resistance system with portions shown in section taken substantially along line 9-9 of FIG. 8.

### DETAILED DESCRIPTION OF THE INVENTION

A wind resistance system according to the concepts of the present invention, generally indicated by the numeral 30 in the accompanying drawings, is used in connection with a movable barrier, such as a garage door system, generally indicated by the numeral 10 in the accompanying drawings. The wind resistance system 30 may be used in connection with a variety of different door systems 10, and consequently only general reference will be made to the door system components other than those directly involved with the wind resistance system 30.

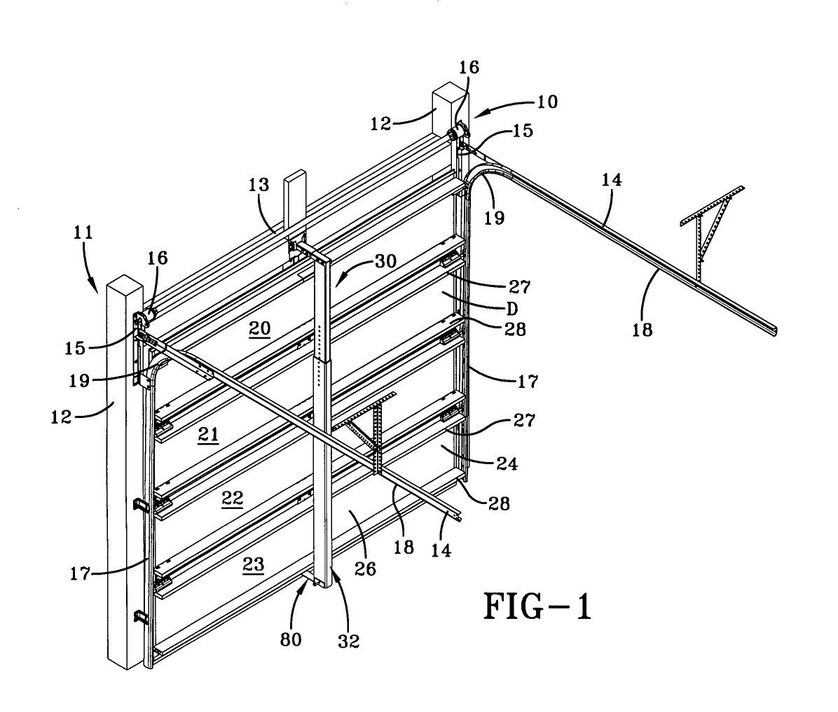

In general, door system 10 is mounted within an opening defined by a framework 11 having a pair of spaced vertical jambs 12 that, as seen in FIG. 1, are generally parallel and extend vertically upwardly from the floor F of the building or other structure that forms a bottom of the opening. Jambs 12 are connected at their upper vertical extremity by a laterally extending header 13. Jambs 12 and header 13 may be constructed of lumber or other structurally appropriate materials, in a manner well known to persons skilled in the art, for the purposes of reinforcement, attachment to the building or other structure, and to facilitate attachment of elements involved in supporting a sectional door D. The door D selectively resides within the opening and is moveable on a pair of guide track assemblies, generally indicated by the numeral 14, that guide the door D between a generally vertical closed position and a generally horizontal open position (not shown).

Affixed to the jambs 12 and proximate the upper extremities thereof are flag angles 15. Flag angles 15 are attached to their underlying jamb member 12 and may be any one of the known configurations employed in the art. As shown in FIG. 1, the flag angles 15 may mount to a counterbalance system, generally indicated by the numeral 16. Counterbalance system 16 offsets the weight of the door D as it is operated on guide track assemblies 14. It should be appreciated that any of a variety of different types of counterbalancing systems may be employed. Although not shown, it will be appreciated that a motorized door operating system may be used to control movement of the door.

Flag angles 15 partially support guide track assemblies 14 on each side of the door D. Track assemblies 14 include a generally vertical track section 17 and a generally horizontal track section 18 which are joined by a curved transition track section 19. Track assembly 14 thus supports and directs the travel of sectional door D in moving from the closed, vertical position depicted in FIG. 1, to the open, horizontal position associated with horizontal track section 18.

For exemplary purposes, a four-panel sectional door D is shown in the drawings; however, it will be appreciated that any number of panels may be employed in the sectional doors of this type, depending upon the height and related considerations of the door opening. As depicted, the sectional door D consists of a top panel 20, an upper middle panel 21, a lower middle panel 22 and a bottom panel 23 which are hinged to one another. Each panel has extending rollers which are received in the track assemblies. Each panel includes a body portion 24 which has an exterior surface 25 and an opposed interior surface 26. Reinforcing struts may be provided to add further structural integrity to the door. Thus an upper reinforcing strut 27 and a lower reinforcing strut 28 may be coupled too, and project rearwardly from interior surface 26.

While the aforementioned door system 10 is structurally adequate to withstand day to day operation, extreme weather conditions inflict abnormally high stresses which may in turn cause door system failure. Specifically, high winds generate pressure differentials between the interior and exterior which in turn may push door D forward or rearward. If the pressure differential is great enough, panels 20-23 may fail, or the door D may become dislodged from the track assemblies 14 and cause significant damage. Once the door system is damaged, the risk of further damage to the structure and its' contents is greatly increased. To prevent door system damage, the wind resistance system, according to the concepts of the present invention, and, generally indicated by the numeral 30, is provided.

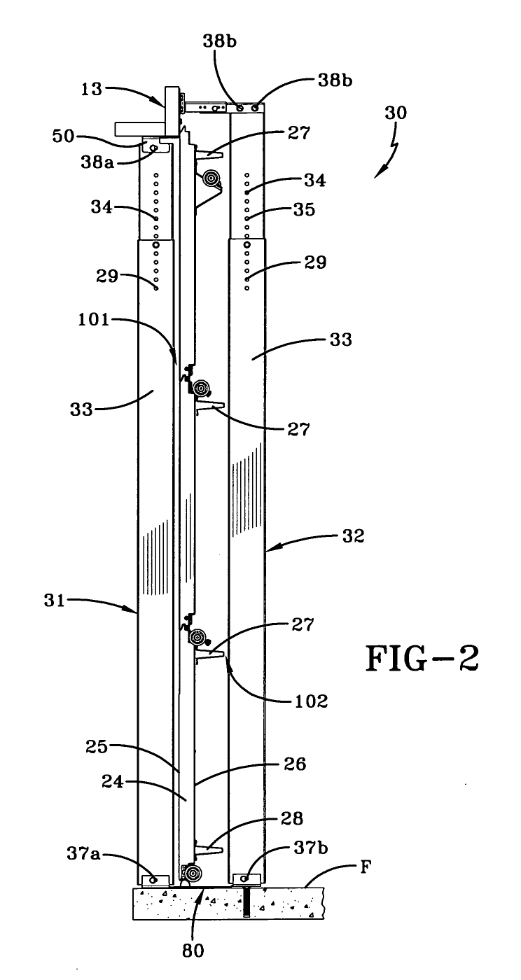

With reference to FIGS. 1 and 2, wind resistance system 30 includes an exterior post 31 which is substantially vertically oriented and positioned forward of door D. An interior post 32 is substantially vertically oriented and positioned rearward of door D. Posts 31 and 32 may be positioned at a location generally central of header 13. It should further be appreciated that, while the present embodiment discloses only one pair of posts 31 and 32, more than one pair may be used. Posts 31 and 32 are adapted to absorb forward or rearward forces and thus may be constructed of relatively high strength materials such as metal, composite plastic or the like. Each post 31 and 32 may have essentially the same 2-part configuration, including a base 33 and an extension 34. Base 33 is an elongated tubular member adapted to slidably receive extension 34 therein. Alternatively, the extension 34 could slidably receive the base, or if desired, the base and extension could be positioned side by side or angularly fitted instead of slidably receivable. In the present embodiment the cross-section of base 33 is rectangular, but it should be appreciated that other cross-sectional shapes may be employed. Extension 34 is an elongated tubular member sized to be slidably received within base 33. Thus, in the present embodiment the cross-section of base 34 is also rectangular. Extension 34 is slidable within base 33 in order to accommodate various door system designs and sizes. Thus, the installer may vary the height of post 31 or 32 by sliding extension 34 selectively up or down within base 33. Once the appropriate post height is achieved the extension 34 may be fixedly coupled to base 33. This may be accomplished by providing a set of vertically spaced holes 29 in base 33 and vertically spaced holes 35 in extension 34. The holes 29 and 35 may then be aligned at the appropriate height and receive a retainer 36 therein. Retainer 36 may be a pin, bolt or any other appropriate securing means. Multiple retainers 36 could be used if desired, provided holes 29 and 35 are adequately aligned. In another embodiment the holes in base 33 and extension 34 may be drilled on site by an installer, once the appropriate post height is determined. Thus in this manner the height of posts 31 and 32 may be adjusted to the appropriate height.

The opposed ends of posts 31 and 32 are secured against movement and, to that end, are each provided with bottom mounting holes 37 and top mounting holes 38. Bottom mounting holes 37 are located proximate to the bottom extremity of base 33 and top mounting holes 38 are located proximate to the upper extremity of extension 34. As will become apparent, holes 37 and 38 may be aligned with holes on various brackets for attachment thereto. It will be further appreciated that components of features specifically associated with exterior post 31 may be provided with an “a” suffix, and components associated with interior post 32 may be provided with a “b” suffix.

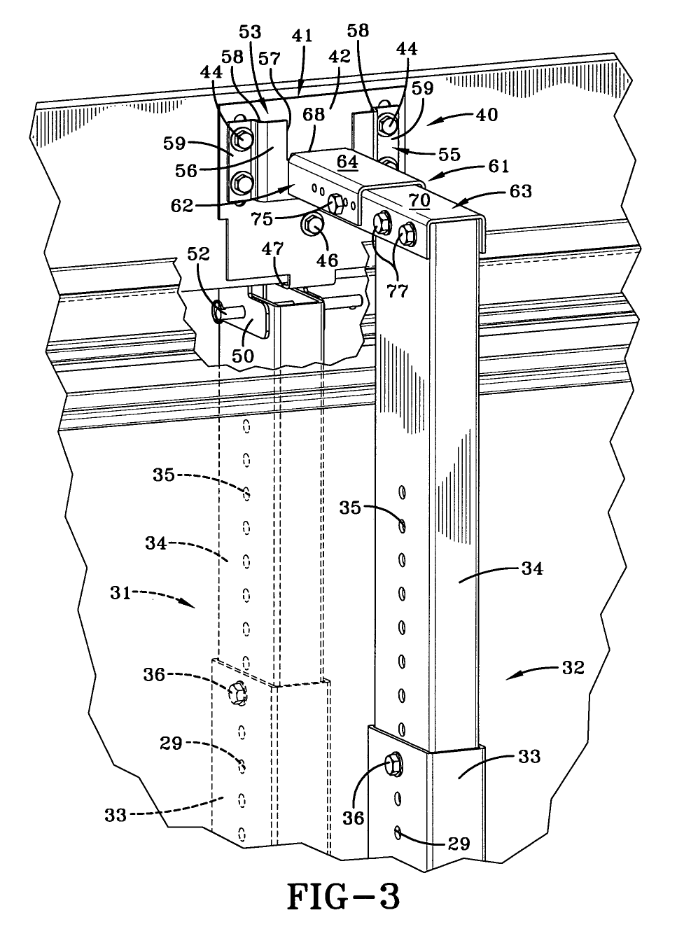

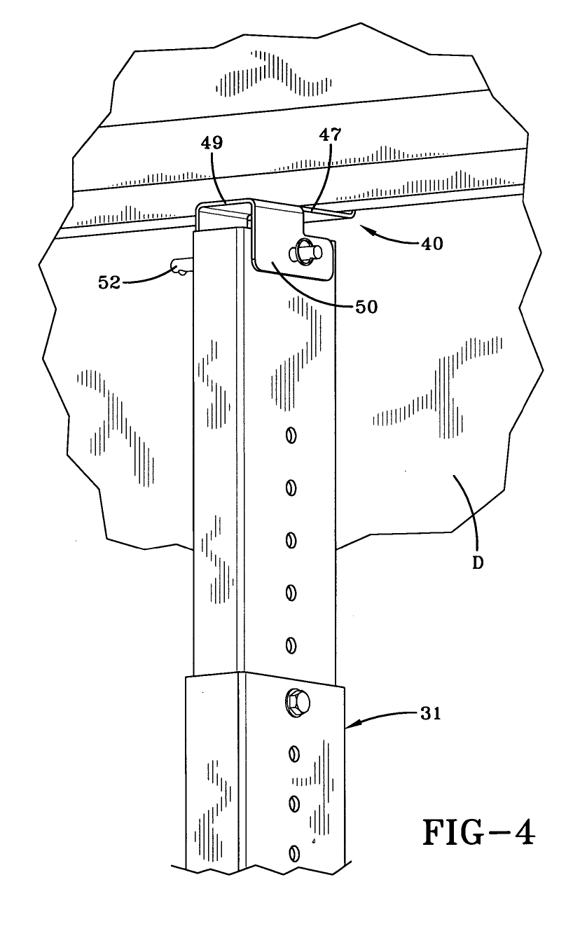

A header mounting assembly, which is designated generally by the numeral 40, is shown in FIGS. 3-5 and is coupled to posts 31 and 32 at their upper vertical extremity. The header mounting assembly 40 is also coupled to the header 13. Header mounting assembly 40 includes a header support 41 which is generally L-shaped and adapted to mount flush with header 13. Header support 41 includes a base plate 42 which may be generally flat and square. Base plate 42 may be secured to the rearward face of header 13 and is provided with a pair of vertically extending elongated slots 43 which are parallel and spaced apart. Each slot 43 is adapted to receive one or more fasteners 44, which may be in the form of a cap screw, bolt or other object receivable in the header 13. Base plate 42 is further provided with a central hole 45 which is adapted to receive a fastener 46 therethrough. Fastener 46 may also be in the form of a cap screw, bolt or other object receivable in header 13 and secures the header support 41 to the header 13.

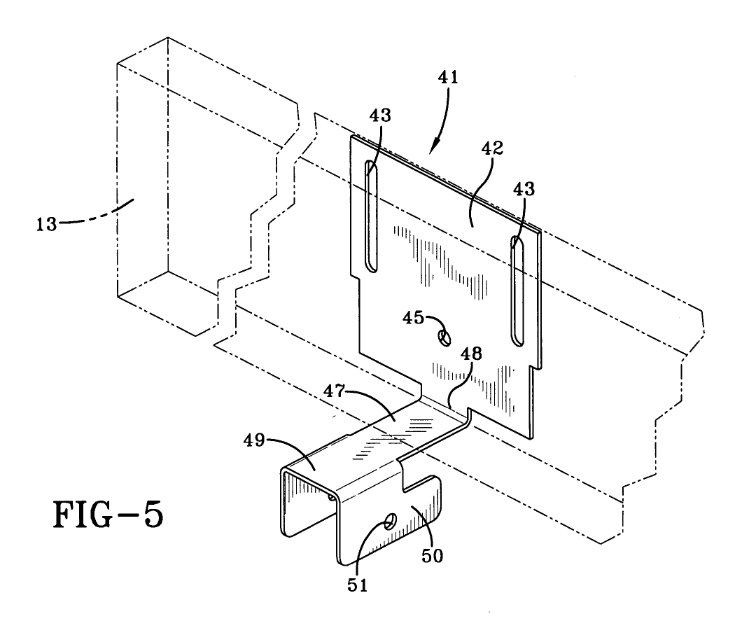

As best seen in FIG. 5, an arm 47 extends forwardly from the bottom edge of base plate 42. Arm 47 is oriented substantially perpendicular to base plate 42 and extends from the interior of the building to the exterior. Thus arm 47 includes an interior end 48 which couples to base plate 42 and an exterior end 49 which extends forward of door D. Arm 47 may be generally flat and is positioned proximate to the bottom surface of header 13 which enables a proper sealing fit of the door D within framework 11. Thus, it should be evident that header mounting assembly 40, and specifically arm 47 does not inhibit or encumber normal door movement. Consequently header mounting assembly 40 may be permanently installed, thus allowing for rapid set up of the remainder of the wind resistance system when the home or business owner desires.

A pair of receiving tabs 50 are located proximate to exterior end 49 of arm 47. Tabs 50 extend downwardly from the sides of arm 47 and are thus parallel and spaced by the width of arm 47. Tabs 50 may be generally L-shaped and are adapted to couple to exterior post 31. Thus, the tabs 50 are spaced to allow extension 34 to fit therebetween. Each tab 50 includes an aperture 51 which may be aligned with top mounting holes 38a of exterior post 31. When assembled, a retainer 52 may be received through aligned apertures 51 and upper mounting holes 38a thereby securing the exterior post 31 to header support 41. Retainer 52 may be in the form of a bolt, clip or detent pin as is known in the art. It should be appreciated that tabs 50 allow exterior post 31 to be quickly and easily positioned and coupled to header mounting assembly 40.

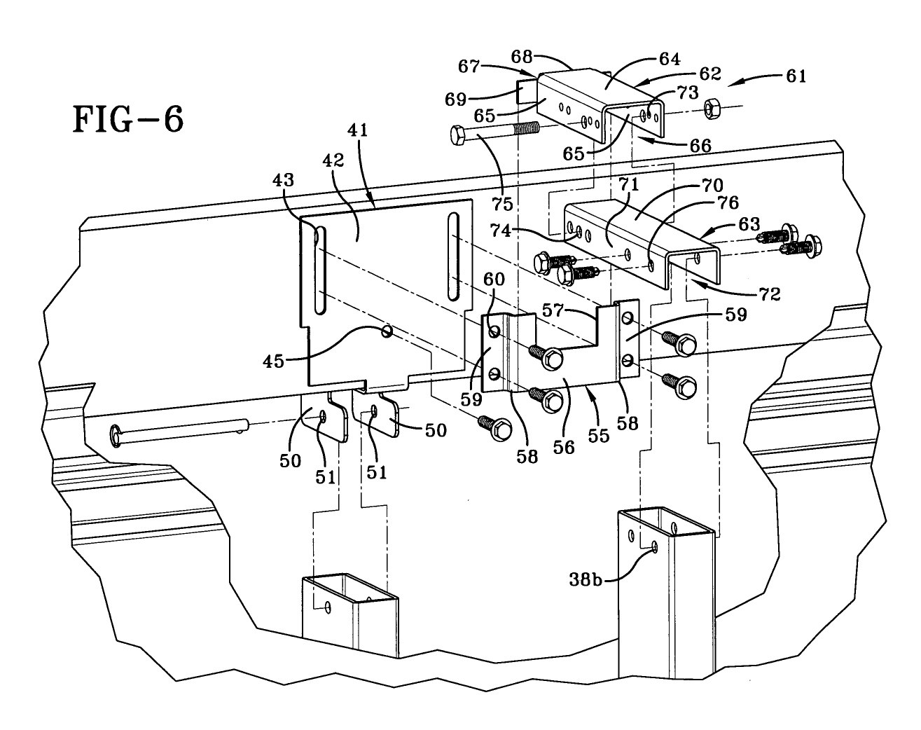

As best seen in FIGS. 3 and 6, header mounting assembly 40 further includes a header bracket 55 which is coupled to header support 41. Header bracket 55 includes a retaining wall 56 which is spaced rearwardly from header support 41 when installed. Retaining wall 56 is provided with a centrally located, upwardly open slot 57 which gives retaining wall 56 a generally U-shaped appearance. Flanges 58 extend forwardly from the opposed sides of wall 56 towards base plate 42 and terminate at feet 59, which are oriented parallel with retaining wall 56. Each foot 59 is provided with at least one hole 60 which is alignable with a respective slot 43 on header support 41. In the present embodiment two holes 60 are provided on each foot 59. Fasteners 44 are received through holes 60 and slots 43 to thereby secure the header bracket 55 and header support 41 to header 13. Thus, it should be evident that header bracket 55 may be adjustably mounted to base plate 42 depending upon the required positioning of header bracket 55. Although adjustable, the bracket 55 may remain in place with the assembly 40 and still allow the door to move between open and closed positions without interference. Further, it should be evident that retaining wall 56 and base plate 42 define a channel 53 therebetween.

A top bracket assembly 61 selectively couples to header bracket 55 via slot 57 as will be hereinafter described. Top bracket assembly 61 includes a first linkage 62 and a second linkage 63. First linkage 62 includes a top wall 64 and a pair of spaced apart, downwardly extending legs 65 which extend from the side edges of top wall 64 forming a generally inverted U-shaped channel 66. Each leg 65 has a plurality of holes 75 that are aligned with holes on the facing leg. An insert 67 extends from the forward end of first linkage 62 proximate to header bracket 55. Insert 67 includes a rounded edge 68 which extends from top wall 64 and terminates at a generally flat, rectangular wing 69 which is wider than the spacing of legs 65. Rounded edge 68 spaces wing 69 from legs 65, creating a gap therebetween. As is evident from FIG. 6, wing 69 is oriented coplanar with retaining wall 56 and is wider than slot 57. When assembled, channel 53 and slot 57 receive insert 67 as shown in FIG. 3. The retaining wall 56 thus resides within the gap between legs 65 and insert 67. As is evident, top bracket assembly 61 is easily coupled to header bracket 55 by positioning edge 68 over slot 57 and moving top bracket assembly 61 downward. In this manner, edge 68 is received in slot 57 and wing 69 interacts with retaining wall 56 to resist rearward movement at first linkage 63. Thus, top bracket 61 may quickly and easily be coupled to or removed from header mounting assembly 40 and header bracket 55.

Second linkage 63 is received within the channel 66 defined by first linkage 62. Second linkage includes a top wall 70 and a pair of spaced apart downwardly extending legs 71 which extend from the side edges of top wall 70 forming a generally inverted U-shaped channel 72. Each leg 71 has a plurality of holes 74 that are aligned with holes on the facing leg. Additionally, each leg 71 is also provided with at least a pair of apertures 76 that are aligned with the apertures on the facing leg. Accordingly, the second linkage 63 nests within the first linkage 62 and is slidably movable with respect thereto. The length of top bracket assembly 61 is adjustable, and thus the plurality of holes 73 and 74 that are provided on legs 65 and on legs 71 respectively are alignable with one another. When the appropriate length is achieved and holes 73 and 74 are aligned, at least one fastener 75 may be inserted within aligned holes 73 and 74 to thereby couple first and second linkages 62 and 63 together.

As is evident from FIG. 3, channel 72 of second linkage 63 is adapted to receive the upper end of interior post 32. Thus, legs 71 are provided with apertures 76 which are aligned with top mounting holes 38b of interior post 32. When so aligned, a retainer 77 may be received therein to secure interior post 32 to top bracket assembly 61. In the present embodiment a pair of top mounting holes 38b are provided and retainers 77 are in the form of bolts. Thus, the attachment between interior post 32 and top bracket 61 is semi-permanent It should be appreciated that retainer 77 may also be in the form of detent pins or other fasteners adapted to secure top bracket 61 to interior post 32.

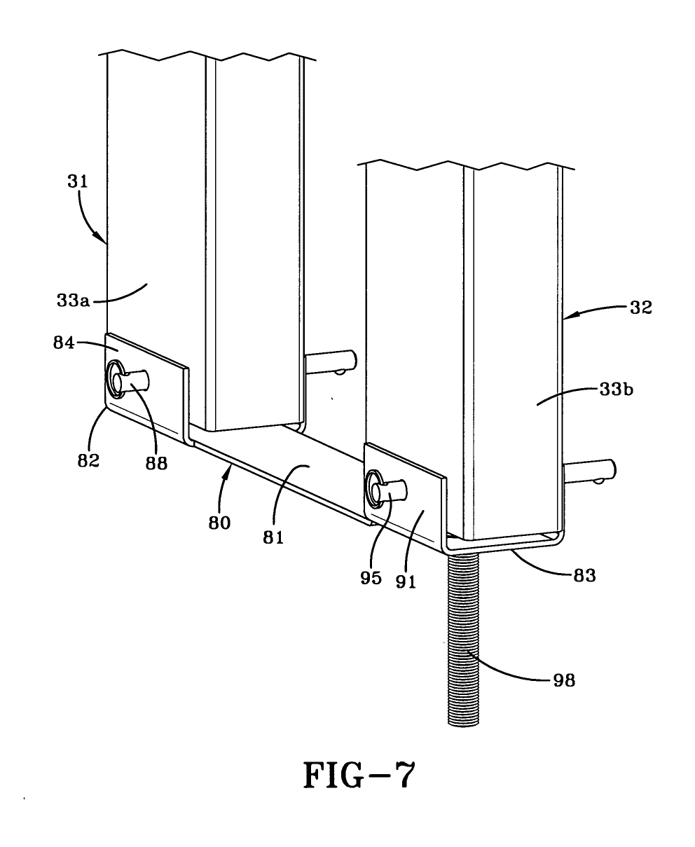

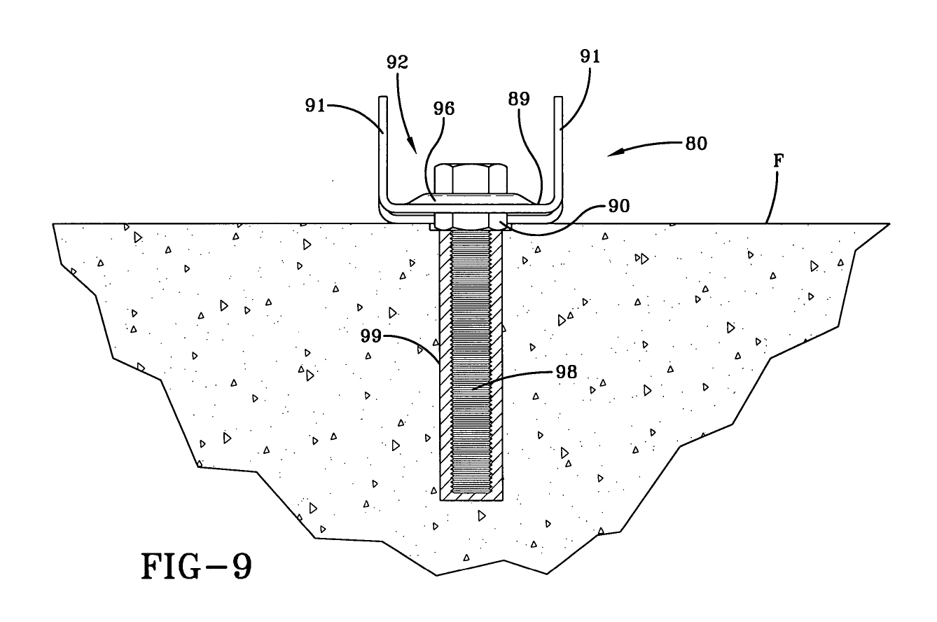

Referring to FIGS. 7-9, posts 31 and 32 are secured at their lower extremity to the floor F via a footer bracket 80. Footer bracket 80 includes a base 81 which may be generally flat. When installed, base 81 extends below the door D and has an exterior end 82 and an opposed interior end 83. Proximate to exterior end 82, a pair of legs 84 extend upwardly and substantially perpendicularly from the sides of base 81 defining a channel 85 therebetween. As is evident from FIG. 7, channel 85 is adapted to receive base 33a of exterior post 31. When base 33 is received in channel 85, bottom mounting holes 37a are aligned with apertures 87 provided in legs 84. When so aligned, a retainer 88 may be inserted, thereby coupling exterior post 31 to footer bracket 80. Retainer 88 may be in the form of a bolt, clip or detent pin. It should be appreciated that legs 84 allow exterior post 31 to be quickly and easily positioned and coupled to footer bracket 80.

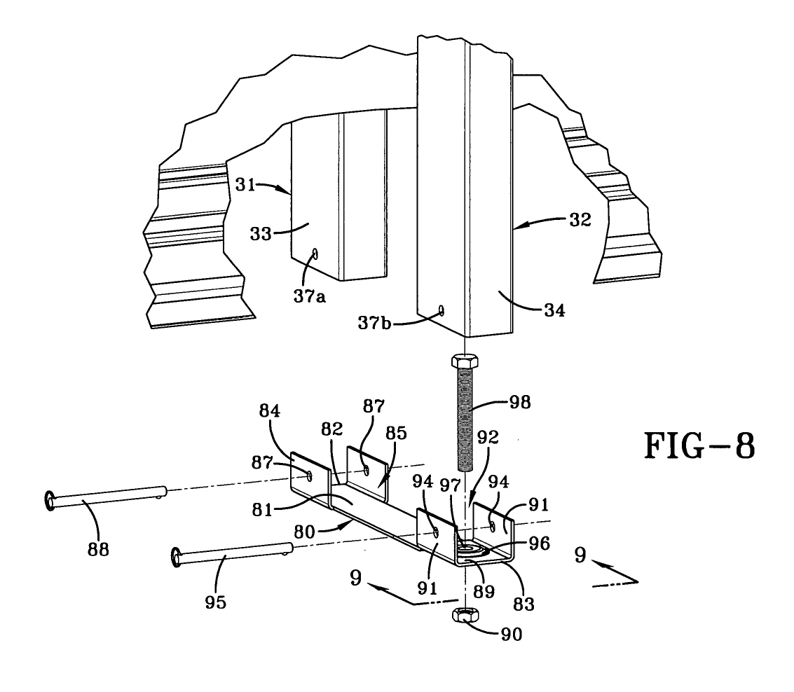

Proximate the interior end 83 of footer bracket 80, a raised step 89 is provided. Step 89 is spaced from floor F and is raised to allow a nut 90 to be positioned between step 89 and floor F. A pair of legs 91 extend upwardly from the sides of step 89 defining a channel 92 therebetween. As is evident from FIGS. 7 and 8, channel 92 receives base 33b of interior post 32. When base 33b is received in channel 92, bottom mounting holes 37 may be aligned with apertures 94 provided in legs 91. When so aligned, a retainer 95 may be inserted, thereby coupling interior post 32 to the footer bracket 80. Retainer 95 may be in the form of a bolt, clip or detent pin. Once again, it should be appreciated that legs 91 allow interior post 32 to be quickly and easily positioned and coupled to footer bracket 80. It should further be appreciated that other means may be employed to couple the posts 31 and 32 to the respective brackets in keeping with the objectives of the present invention.

Step 89 may further include a raised annular lip 96 which may be positioned centrally on step 89 and extend upwardly therefrom. Annular lip 96 defines an aperture 97 which is adapted to receive anchor 98 therein. Aperture 97 is aligned with a hole 99 provided in floor F. Anchor 98 is received through aperture 97, nut 90 and finally into hole 99, thereby securing footer bracket 80 to floor F. Anchor 98 may include threads which engage the threads of nut 90. Further, hole 99 may be smooth and thus slidably receive anchor 98. In this manner, posts 31 and 32 are secured to footer bracket 80 which is in turn secured to floor F.

Thus assembled, exterior post 31 is secured outside the building, forward of door D and interior post 32 is secured inside the building rearward of door D. In other words, the door D is positioned between the exterior and interior posts 31 and 32 which are in turn secured against movement at their lower and upper extremity. While the posts 31 and 32 are positioned proximate to door D, they are not physically coupled thereto. As will become apparent, because no physical attachment to the door D is required, installation and use of wind resistance systems 30 is made easier. Indeed, in one or more embodiments, a gap is defined between the door D and posts 31 and 32. Specifically, as best seen in FIG. 2, a first gap 101 is defined between the exterior surface 25 of door D and exterior post 31. Further, a second gap 102 is defined between the rearward face of reinforcing struts 26,27 and the interior post 32. If no reinforcing struts 26,27 are provided, the second gap 102 is defined between the interior surface 26 and interior post 32. Accordingly, the only direct contact between the wind resistance system 30 and the door system 10 is where a bottom edge of door D contacts the base 81, and where a top edge of door D contacts the arm 47. And such contact does not significantly impede flexible movement of the door in high wind conditions.

In high wind conditions the door D will flex depending upon pressure loads. As the door flexes, the gaps 101 and 102 may be taken up and if sufficient pressure is applied, the door D may contact post 31 or 32. For example, if a sufficiently large rearwardly acting pressure is applied to door D, (i.e. positive pressure acting on exterior surface 25), the door D will deflect and reinforcing struts 26, 27 will eventually contact the interior post 32. Further deflection is then prevented by interior post 32, which is secured against movement at it's upper and lower extremity. It is known through experimentation that if a door deflects beyond about 6 inches, a high incidence of failure occurs. Thus, in one or more embodiments gaps 101 and 102 maybe less than about 6 inches. In another embodiment, the gaps 101 and 102 may be from about 2 to 3 inches. In still other embodiments, the gaps 101 and 102 may be from about 0.5 to about 2 inches.

Some components of the wind resistance system 30 may be installed prior to a high wind weather event, and thus enable the home or structure owner to quickly install the remaining components close in time to when the high wind event occurs. Specifically, it should be appreciated that header mounting assembly 40 may be installed prior to the high wind condition as disclosed above. Further, hole 99 may be drilled or otherwise created in floor F and posts 31 and 32 may be adjusted to the proper height wherein retainers 36 are installed to maintain the height of the posts. Further, top bracket assembly 61 may be coupled to interior post 32 and extended to the correct length so that the interior post 32 is properly aligned with channel 92 of footer bracket 80, as shown in FIG. 2. Once proper length is achieved, fasteners 75 may be inserted in holes 73 and 74 to thereby semi-permanently couple first and second linkages 62 and 63 together. Thus adjusted and aligned, posts 31 and 32 may be removed and placed in an appropriate storage location. Exterior post 31 is removed by removing retainers 52 and 88 thereby decoupling exterior post 31 from header support 41 and footer bracket 80. Interior post 32 may be removed by first removing retainer 95. Interior post 32, along with top bracket assembly 61 which is secured thereto, may then be moved upwardly. The upward movement allows wing 69 and edge 68 to exit slot 57 and channel 53. Interior post 32 may then be placed in an appropriate storage location. Finally, anchor 98 of footer bracket 80 may be removed from hole 99 in floor F thereby releasing footer bracket 80 so that it may be placed in an appropriate storage location. Thus, header support 41 and header bracket 55 may remain in place during normal door operation as the components thereof do not interfere with normal door movement.

Assembly of the wind resistance system may be accomplished by first opening door D. Next, footer bracket 80 and nut 90 are positioned on floor F and retained thereto by inserting anchor 98 through aperture 97, nut 90 and into hole 99. Alternately, prior to assembly, anchor 98 may be inserted through aperture 97 and secured to footer bracket 80 by nut 90, thus assemblied, anchor may then be inserted into hole 99. In either event, the door D may then be moved from the open to the closed orientation, as shown in FIGS. 1 and 2. Once door D is closed, and the operator system used to move the door is disengaged, exterior post 31 may be positioned forward of door D and coupled to footer bracket 80 and header support 41. Next, wing 69 of top bracket 61 which is in turn coupled to interior post 32, is positioned above channel 53. Interior post 32 is then moved downward, causing edge 68 to be received in slot 57 and causing wing 69 to be received in channel 53 and retained between base plate 42 and retaining wall 56. Interior post 32 is then coupled to footer bracket 80, thereby completing the assembly.

In summary, the present invention advances the art of barrier reinforcement by providing a wind resistance system which is easily and quickly assembled and provides protection against both positive and negative wind pressures. Further, the wind resistance system is not directly attached to the door, which allows the use of weaker barrier panel facer materials that may not have sufficient strength for the attachment of reinforcement brackets directly to the surface. The above disclosed wind resistance system further provides for more secure containment of the door, as even if panels break loose from the tracks, they are contained between the posts and prevented from damaging the structure or articles therein.

Thus, it should be evident that the wind resistance system for a movable barrier disclosed herein constitutes an advantageous contribution to the art. As will be apparent to persons skilled in the art, modifications can be made to the preferred embodiments disclosed herein without departing from the spirit of the invention, the scope of the invention herein being limited solely by the scope of the attached claims.

1. A door system for a door opening defined by a pair of vertically spaced jambs, a header positioned near the vertical extremity of the jambs, and a floor supporting the jambs, the door system comprising, a door, a plurality of track sections, said door being movable on said track sections, an exterior post positioned forward of said door, an interior post positioned rearward of said door, wherein said exterior and said interior posts are adapted to oppose deflection of said door.

2. The door system of claim 1, wherein said exterior and said interior posts are positioned proximate the lateral center of said door.

3. The door system of claim 1, wherein said exterior post and said door define a first gap therebetween, said exterior post preventing forward deflection of said door after said first gap is taken up.

4. The door system of claim 3, wherein said interior post and said door define a second gap therebetween, said interior post preventing rearward deflection of said door after said second gap is taken up.

5. The door system of claim 4, wherein said first and said second gap being less than six inches.

6. The door system of claim 5 wherein said first and said second gap being between two and three inches.

7. The door system of claim 4, wherein said first and said second gap being between 0.5 and two inches.

8. The door system of claim 1, further comprising a footer bracket adapted to be secured to the floor, having an exterior end positioned forward of said door and an interior end positioned rearward of said door, said exterior and said interior posts being coupled to said footer bracket.

9. The door system of claim 8, further comprising an anchor, said footer bracket including an aperture, and the floor adapted to provide a hole, said anchor being removably received in said aperture and the hole.

10. The door system of claim 8, further comprising retainers, wherein said exterior and said interior posts are releasably coupled to said footer brackets by said retainers.

11. The door system of claim 10 wherein said retainers comprise detent pins.

12. The door system of claim 1, further comprising a header mounting assembly positioned above said door and having an exterior portion and an interior portion, said exterior and said interior posts being coupled to said header mounting assembly.

13. The door system of claim 12, wherein said header mounting assembly is adjustable.

14. The door system of claim 12, wherein said header mounting assembly is coupled to said header.

15. The door system of claim 1, further comprising a header bracket and a top bracket, said header bracket being operatively coupled to said header and defining a channel, said top bracket being coupled to said interior post, wherein a portion of said top bracket is slidably received in said header bracket, thereby preventing forward or rearward movement thereof.

16. The wind resistance system of claim 1, wherein said posts include a base and an extension, said extension being slidable in said base to vary the height of said posts.

17. The door system of claim 1, wherein said exterior post is linked to said interior post.

18. The door system of claim 1, wherein one end of said exterior post is linked to one end of said interior post.

19. The door system of claim 1, wherein said exterior post includes a top end and a bottom end and said interior post includes a top end and a bottom end, and wherein said exterior and said interior bottom ends are linked and said exterior and said interior top ends are linked.

20. The door system of claim 1, wherein exterior and said interior posts do not contact said door.

21. A wind resistance system for a movable door having an interior surface and an exterior surface, the wind resistance system comprising an exterior post positioned forward of the door, an interior post positioned rearward of the door, a footer bracket positioned below the door and a header mounting assembly positioned above the door, said interior and said exterior posts being releasably coupled to said footer bracket, and said interior and said exterior post being releasably coupled to said header mounting assembly, wherein said posts prevent excessive door deflection.

22. The wind resistance system of claim 21, wherein said posts include a base and an extension, said extension being slidable in said base to vary the height of said posts.

23. The wind resistance system of claim 21, further comprising a header support which includes a base plate and an arm, said base plate being rearward facing and coupled to said header, and said arm extending perpendicularly forward from said base plate, wherein said exterior post couples to said arm.

24. The wind resistance system of claim 21, wherein said header mounting assembly is coupled to said header.

25. The wind resistance system of claim 24, wherein said header mounting assembly is adjustable.

26. The wind resistance system of claim 21, further comprising an anchor, said footer bracket including an aperture, said anchor being removably received in said aperture to secure said footer to a floor.

27. A method of preventing wind damage, the method comprising, providing a door movable on a plurality of tracks, moving said door to a close generally vertical orientation, providing an exterior post positioned forward of said door, providing an interior post positioned rearward of said door, securing said exterior and said interior posts against movement.

28. The method of claim 27, wherein said step of securing said posts against movement further comprises the steps of:
placing a footer bracket below said door, said footer bracket having an exterior end forward of said door and an interior end rearward of said door;
securing said exterior post to said exterior end; and
securing said interior post to said interior end.

29. The method of claim 28, further comprising securing said exterior and said interior posts to said footer bracket by pins.

30. The method of claim 27, further comprising vertically adjusting said exterior and said interior posts prior to the securing step.

31. The method of claim 27, further comprising securing said exterior and said interior post so as to avoid contact with said door.

32. The method of claim 27, wherein said step of securing said exterior and said interior posts against movement further includes the steps of:
securing a header mounting assembly to a header, said header mounting assembly having an exterior portion and an interior portion;
securing said exterior post to said exterior portion; and
securing said interior post to said interior portion.

33. The method of claim 32, wherein said exterior and said interior posts are secured to said header mounting assembly by pins.
